(19) United States
(12) Patent Application Publication
(10) Pub. No.: US 2005/0019540 A1
(43) Pub. Date: Jan. 27, 2005

(54) Aluminum based composite material and process for manufacturing the same

(76) Inventors: Motoharu Tanizawa, Kariya-shi (JP); Kyoichi Kinoshita, Kariya-shi (JP); Manabu Sugiura, Kariya-shi (JP); Masakazu Murase, Kariya-shi (JP)

Correspondence Address: KNOBLE YSOHIDA & DUNLEAVY LLC;Suite 1350, Eight Penn Center, 1628 John F. Kennedy Blvd., Philadelphia, PA, 19103, US

(21) Appl. No.: 10/894,566

(22) Filed: Jul. 20, 2004

(30) Foreign Application Priority Data
Jul. 23, 2003 (JP) 2003-200805

(51) Int. Cl. B22D 19/14; B32B 5/02

(52) U.S. Cl. 428/293.1; 164/97; 164/98; 428/332; 428/401

(57) ABSTRACT

An aluminum based composite material includes a matrix and a reinforcing material. The matrix mainly contains aluminum and contains magnesium. The reinforcing material is constituted of whisker and nitriding short fiber which is treated by nitriding process. The reinforcing material is dispersedly contained in the matrix. The aluminum based composite material has a high thermal resistance.

### BACKGROUND OF THE INVENTION

The present invention relates to a practical aluminum based composite material which has a high thermal resistance and to a process for manufacturing the same.

Recently, weight saving has been dealt with in various fields including automobiles and industrial vehicles. An aluminum alloy has mainly been used in place of conventional iron and steel materials. Particularly, in the case of automobiles, aluminum alloy components have been used in view of low fuel consumption, high heat transfer efficiency, recycling, and the like.

An aluminum alloy generally has a low strength and a low sliding characteristic in comparison to a steel material and a cast iron material. In order to reinforce those characteristics, various aluminum based composite materials which are one of metal matrix composites (MMC) dispersedly containing various whiskers and ceramic fibers have been proposed.

For example, Examined Japanese Patent Publication No. 63-40943 discloses a swash plate of a swash plate type compressor for an air conditioner, whose swash plate is made of aluminum based composite material dispersedly containing alumina short fiber and silicon carbide (SiC) whisker in the aluminum alloy (A390). By using the above composite, a rotor or a swash plate has gained a high strength, a high abrasion resistance and a high seizure resistance.

Unexamined Japanese Patent Publication No. 63-216936 discloses a high abrasion-resistant aluminum based composite material, which dispersedly contains 20 percent by volume of alumina (Al₂O₃) fiber and 5 percent by volume of silicon carbide (SiC) whisker in the aluminum alloy (A6061).

Unexamined Japanese Patent Publication No. 9-279267 discloses a high thermal-conductive aluminum based composite material, which dispersedly contains aluminum nitride fiber and silica-alumina based fiber or aluminum borate whisker in the aluminum alloy (AC8A).

Unexamined Japanese Patent Publication No. 2001-335900 discloses an aluminum based composite material dispersedly containing alumina nitride-silica fiber and carbon fiber in the aluminum alloy (ADC12). By using the above composite, a cylinder liner of an engine has gained a high abrasion resistance.

Thus, various aluminum based composite materials have been proposed to dispersedly contain reinforcing materials made of various fibers in the aluminum alloys. However, in any conventional aluminum based composite materials, a reinforcing material dispersedly contained in the matrix has mainly been selected for improving sliding characteristic, abrasion resistance, thermal conductivity and the like. Therefore, there is a need for providing a practical aluminum based composite material having a high thermal resistance which is different from the views of the prior arts.

### SUMMARY OF THE INVENTION

In accordance with the present invention, an aluminum based composite material includes a matrix and a reinforcing material. The matrix mainly contains aluminum and contains magnesium. The reinforcing material is constituted of whisker and nitriding short fiber which is treated by nitriding process. The reinforcing material is dispersedly contained in the matrix.

Furthermore, in accordance with the present invention, a process for manufacturing an aluminum based composite material includes preparing a nitriding preform including whisker and nitriding short fiber, placing the nitriding preform in a mold, impregnating a molten aluminum alloy containing magnesium into the nitriding preform by pouring the molten aluminum alloy into the mold while the molten aluminum alloy is being pressurized, and solidifying the molten aluminum alloy for obtaining the aluminum based composite material.

Other aspects and advantages of the invention will become apparent from the following description, taken in conjunction with the accompanying drawings, illustrating by way of example the principles of the invention.

### DETAILED DESCRIPTION OF THE PREFERRED EMBODIMENTS

A preferred embodiment according to the present invention will now be described. An aluminum based composite material will mainly be described but the description is also applicable to a process for manufacturing the aluminum based composite material. Incidentally, the word, “whisker” in the description means not only whisker before nitriding but also whisker after nitriding if nothing is specifically defined. Likewise, the word, “short fiber” means not only short fiber before nitriding but also short fiber after nitriding.

“Whisker” is called crystal whiskers which are needle crystal obtained by oxidation-reduction reaction, thermal decomposition and the like. The whisker generally has critically less number of dislocations in its crystal and has an extremely high strength. The whisker has an average diameter of 0.1 to 1 μm and an average length of 1 to 50 μm. Correspondingly, “short fiber” has an average diameter of 1 to 10 μm and an average length of 20 to 500 μm. Incidentally, “long fiber” is a continuous fiber having an average diameter of 1 to 50 μm. The above described whisker, short fiber and long fiber are clearly known to have distinguished characteristics among those skilled in the relevant art based upon manufacturing process, quality of material, size and the like.

(1) Matrix

A matrix of an aluminum based composite material according to the present invention is made of an aluminum alloy containing Mg as a reinforcing element. The matrix is a base of the composite, and an appropriate composition should be selected according to its application that mainly depends upon mechanical characteristic, processability, castability and the like.

Alternatively, an aluminum alloy used for matrix may be a binary alloy as a base such as Al—Mg, Al—Cu, Al—Si, Al—Mn and Al—Zn. There may also be a ternary alloy, a quaternary alloy and the like which combine the above aluminum alloys. Furthermore, a small amount of Ni, Cr, Zr, Ti and the like may be added for any purpose. For ingoting the aluminum based composite material according to the present invention or impregnating molten aluminum alloy to a preform including whisker and nitriding short fiber, the aluminum alloy for matrix employs a casting aluminum alloy such as AC1 through AC9 and a die-casting aluminum alloy such as ADC1 through ADC14 according to Japanese Industrial Standard (or JIS).

For obtaining further strength, thermal resistance, corrosion resistance and the like, an aluminum alloy having a composition corresponding to 2000 series, 3000 series, 4000 series, 5000 series, 6000 series or 7000 series aluminum alloy are employed for matrix. Particularly, for obtaining high strength, the matrix preferably has a composition corresponding to duralumin (A2017), superduralumin (A2024) or ultra superduralumin (A7075). One example of the composition of the matrix is Si of from about 0.1 to about 0.9 percent by mass, Fe of from about 0.3 to about 0.9 percent by mass, Cu of from about 3 to about 6 percent by mass, Mn of from about 0.1 to about 1.5 percent by mass, Mg of from about 0.4 to about 6 percent by mass, Zn of from about 0.1 to about 7 percent by mass and Cr of from about 0.1 to about 0.4 percent by mass.

When the existing composition is used as a base, the amount of Mg is preferably increased by from about 0.5 to about 2.5 percent by mass. The amount of Mg consumed for generating an Mg compound is reduced by using nitriding short fiber, but Mg in the matrix may be consumed depending upon the extent of nitriding. In such a case, if the amount of Mg is increased, the matrix is prevented from losing strength.

(2) Reinforcing Material

The reinforcing material of the aluminum based composite material according to the present invention includes whisker and nitriding short fiber.

Whisker materials include silicon carbide whisker (SiCw), aluminum borate whisker (AlBO₃W), aluminum oxide whisker (Al₂O₃w). One, two or more of those whisker materials are appropriately selected. If these whiskers have been nitride treated by nitriding process, the reaction with Mg in the matrix is preferably prevented.

Short fiber materials include alumina fiber (Al₂O₃) and alumina-silica fiber (Al₂O₃—SiO₂). One, two or more of those fibers are appropriately selected. The nitriding short fiber is manufactured by nitriding the above short fibers. The reaction with Mg in the matrix is prevented as described above by using the nitriding short fiber.

As the amount of whisker dispersed in the matrix increases, an aluminum based composite material tends to have a high strength, but it leads to possible deterioration and high cost. Also, an increased amount of nitriding short fiber dispersed in the matrix effectively reinforces the aluminum based composite material but does not improve the strength as much as whisker. It is also difficult in the first place to disperse a large amount of short fiber nitriding in the matrix because it involves cast defects and the like.

Based on the above descriptions, where the total of aluminum based composite material is defined as 100 percent by volume, preferably nitriding short fiber is from about 4 to about 18 percent by volume, and the sum of nitriding short fiber and whisker is from about 12 to about 30 percent by volume. If the nitriding short fiber is less than about 4 percent by volume, the amount of dispersed whisker increases for ensuring strength, thermal resistance and the like, so that it is not preferable in view of processability and manufacturing cost. If the nitriding short fiber exceeds about 18 percent by volume, it is difficult for the nitriding short fiber to be dispersed in molten aluminum based composite material or to impregnate molten aluminum based composite material thereby to easily produce the cast defect and the like. Thus, it is further preferred that the nitriding short fiber is from about 8 to about 12 percent by volume.

The fine whisker is trapped into the clearance between short fibers so that a comparatively large amount of whisker is dispersed into the matrix. However, an increase in the dispersed whisker leads to possible deterioration and higher cost as described above so that the sum of the whisker and the nitriding short fiber is preferably from about 12 to about 30 percent by volume in view of correlation with the nitriding short fiber. This means that the whisker by itself is from about 8 to about 12 percent by volume. More preferably, the sum of the whisker and the nitriding short fiber is from about 12 to about 22 percent by volume, and the whisker by itself is from about 8 to about 10 percent by volume.

Nitriding of short fiber or whisker is gas nitriding, gas nitrocarburizing, salt bath nitriding and the like, and the gas nitriding process is preferable for nitriding the fine short fiber or whisker. In the gas nitriding process, for example, the short fiber or whisker is heated up from about 1200 to about 1600° C. in mixed gas of carbon dioxide and ammonia gas or in ammonia gas.

(3) Manufacturing Process

Upon manufacturing the aluminum based composite material, possibly molten aluminum alloy containing previously mixed and agitated whisker and short fiber is poured into a mold. However, in this case, the whisker and particularly the nitriding short fiber agglomerate thereby to hardly obtain the aluminum based composite material dispersedly containing the reinforcing material in the matrix in a uniform manner. Then, a preform of the whisker and the short fiber is previously formed. Subsequently, the molten alloy is preferably pressurized and poured into the above preform before it is impregnated as well as solidified.

Such preform may be prepared by vacuum molding or filtration after short fiber and whisker are dispersed in the water. The shape of the preform may be selected according to the shape of the component.

The molten alloy is impregnated into the preform while it is being pressurized by plunger and the like. Then, molten metal forging, die-casting and the like are preferred for casting. The pressure is added and then varied depending upon an occupation volume fraction (Vf) of the preform and the composition of the molten alloy. However, the preferred pressure is from about 50 to about 150 MPa. The temperature of the molten alloy is also varied depending upon the composition of the molten alloy and molding process. However, the temperature is preferred from about 650 to about 850° C. Then, the preform and the die are previously heated to ensure the impregnating ability of the molten alloy. The preheating temperature of the die is, for example, from about 150 to about 350° C.

It is preferable that the aluminum based composite material is further heat treated after molding. For example, in accordance with the composition of the matrix, solution heat treatment and artificially ageing treatment may be performed and are respectively regulated in Japanese Industrial Standard (or JIS) as T4 treatment and T6 treatment.

(4) Application

The aluminum based composite material according to the present invention has a high strength, a high thermal resistance, a high processability and the like and also helps reduce the associated costs thereby to be used for many products in various fields. Particularly, it is preferable for a big-volume product which is required to have a high heat resistance and a low cost. In the field of automobiles, for example, the aluminum based composite material may be used for a pump, a housing of a compressor and the like to which high pressure is applied. Also, the aluminum based composite material may be used for a pipe-shaped conduit and the like.

Additionally, although the above described compressor is mainly used for a car air conditioner, it is applicable that the aluminum based composite material according to the present invention may be used for a constituent component of a compressor for another kind of air conditioner. Furthermore, the aluminum based composite material is not only limited to the field of the automobile but also used in the fields of electrical equipment, household equipment, productive facilities and the like.

The heat resistance of the aluminum based composite material according to the present invention is, for example, evaluated by tensile strength after heating the composite at about 200° C. for about 165 hours. This tensile strength is preferably about 300 MPa or above, more preferably about 310 MPa or above, and most preferably about 320 MPa or above. Naturally, tensile strength at a room temperature before going through its thermal history is desirably higher, preferably about 400 MPa or above, more preferably about 430 MPa or above, most preferably about 460 MPa or above, and the best about 500 MPa or above.

### EXAMPLE

An example according to the present invention will now be described.

An aluminum based composite material for use in a housing of a compressor for a car air conditioner was variously manufactured and evaluated as below. It is noted that the compressor for a car air conditioner is a high pressure type which is mounted in an engine room of an automobile. Therefore, the housing of the compressor needs to have not only a high strength but also a high thermal resistance.

(Manufacturing of Aluminum Based Composite Material)

Aluminum based composite materials dispersedly containing various reinforcing materials as shown in TABLE 1 in the matrix were manufactured. An aluminum alloy corresponding to A2024 according to JIS was used as a matrix. The detailed composition of this matrix was about 0.5 percent by weight of Si, about 0.5 percent by weight of Fe, from about 3.8 to about 4.9 percent by weight of Cu, from about 0.3 to about 0.9 percent by weight of Mn, from about 2.2 to about 3.8 percent by weight of Mg, about 0.25 percent by weight of Zn and the remainder of Al (unit: percent by weight).

In any aluminum based composite materials, a preform or nitride made of reinforcing material was formed, and the above molten matrix alloy was poured into a die where the preform was being pressurized thereby to manufacture the aluminum based composite material. The preform was treated by the following nitriding process when it was necessary. Manufacturing of the aluminum based composite material of sample No. 1 will now be described. However, except for a kind of reinforcing material and the nitriding treatment, other samples were manufactured in the same manner as the sample No. 1.

As shown in TABLE 1, alumina-silica short fiber and SiC whisker were place in the compound according to be percent values by weight as shown in TABLE 1 and were agitated for about 30 minutes until they were uniformly mixed in the water. After the agitation, silica sol of about 5 percent by weight was further added as a binder thereby to form the preform of 10×80×80 (mm).

The obtained preform had been thermally treated in NH₃ gas containing LPG of about 5% at about 1400° C. for about 2 hours and then treated by nitriding process thereby to form the nitriding preform.

During the impregnating process, the molten aluminum alloy was impregnated into this nitriding preform with pressure of from about 80 to about 100 MPa being applied to the molten alloy. It is noted that the die and the nitriding preform had been previously heated to from about 500 to about 800° C. before this impregnating process. Radiating heat after the impregnating process, the 10×80×80 (mm) aluminum based composite material was obtained after the solidification process. During the thermal treatment process, the obtained aluminum based composite material was treated by the solution heat treatment, that is, the composite had been heated at about 200° C. for about 10 hours followed by cooling with water. Subsequently, the composite was treated by artificially age hardening, that is, the composite had been heated at about 170° C. for about 10 hours heating, which corresponds to T6 thermal treatment according to the JIS.

The alumina-silica short fiber shown in TABLE 1 has a composition of about 52% of SiO₂ and about 48% of Al₂O₃, an average diameter of from about 2 to about 4 μm, and a fiber length of from about 50 to about 200 μm. The corresponding commercial name is Engineered fiber, which is produced by Saint-Gobain™ K.K. Alumina (Al₂O₃) short fiber has an average diameter of from about 2 to about 4 μm, and a fiber length of from about 50 to about 200 μm. The corresponding commercial name is Saphir, which is produced by ICI. SiC whisker has an average diameter of from about 0.3 to about 1.4 μm, and a fiber length of from about 5 to about 30 μm. The corresponding commercial name is Tokawhisker, which is produced by Tokai Carbon Co., Ltd. AIBO₃ whisker has an average diameter of from about 0.5 to about 1 μm, and a fiber length of from about 10 to about 30 μm. The corresponding commercial name is Alborex, which is produced by Shikoku Chemicals Corp.

(Measurement and Evaluation)

Thus, the above obtained aluminum based composite materials were examined by a tensile test. This tensile test was performed on a test piece in a virgin state after the above thermal treatment process and after thermal history for which the test piece is held in a furnace of the atmosphere at about 200° C. for about 165 hours. The test result is also shown in TABLE 1. It is noted that the tensile test was performed at a room temperature by universal tensile tester, which is produced by Shimadzu Corp.

The aluminum based composite materials dispersedly containing short fiber and whisker in hybrid as in the samples No. 1 and 2 had been substantially improved both in the initial tensile strength and the tensile strength after the thermal history in comparison to the aluminum based composite materials dispersedly containing only short fiber as in the samples No. 3 and 4. Particularly, the tensile strength after the thermal history had been improved to be comparable with the aluminum based composite material containing only whisker as in the samples No. 5 and 6.

TABLE 1

| | Reinforcing Material | | | | | Tensile Strength | |
|---|---|---|---|---|---|---|---|
| | | | | | Total | | |
| | | | | | Volume | | After |
| | Short Fiber | | Whisker | | Fraction of | | 200° C. × |
| | | Volume | | Volume | Reinforcing | Initial | 165 |
| Sample | | Fraction | | Fraction | Material | Stage | hrs |
| No. | Kind | Vf1 (vol %) | Kind | Vf2 (vol %) | (Vf1 + Vf2) | (MPa) | (MPa) |
| 1 | Alumina-Silica | 12 | SiC | 6 | 18 | 543 | 445 |
| 2 | Alumina-Silica | 12 | AlBO₃ | 12 | 24 | 523 | 438 |
| 3 | Alumina-Silica | 12 | — | — | 12 | 455 | 335 |
| 4 | Alumina | 12 | — | — | 12 | 291 | 267 |
| 5 | — | — | SiC | 16 | 16 | 605 | 455 |
| 6 | — | — | AlBO₃ | 25 | 25 | 433 | 372 |

Therefore, the present examples and embodiments are to be considered as illustrative and not restrictive, and the invention is not to be limited to the details given herein but may be modified within the scope of the appended claims.

1. An aluminum based composite material comprising:
a matrix mainly containing aluminum and containing magnesium; and
a reinforcing material constituted of whisker and nitriding short fiber which is treated by nitriding process, the reinforcing material being dispersedly contained in the matrix.

2. The aluminum based composite material according to claim 1, wherein the nitriding short fiber is from about 4 to about 18 percent by volume, a sum of the nitriding short fiber and the whisker being from about 12 to about 30 percent by volume, where a total of the aluminum based composite material is defined as 100 percent by volume.

3. The aluminum based composite material according to claim 2, wherein the nitriding short fiber is from about 8 to about 12 percent by volume.

4. The aluminum based composite material according to claim 2, wherein the sum of the nitriding short fiber and the whisker is from about 12 to about 22 percent by volume.

5. The aluminum based composite material according to claim 1, wherein the whisker is made of one or combination selected from the group consisting of silicon carbide, aluminum borate and aluminum oxide.

6. The aluminum based composite material according to claim 1, wherein the whisker is nitriding whisker which is treated by nitriding process.

7. The aluminum based composite material according to claim 1, wherein the nitriding short fiber is made by nitriding short fiber which is constituted of one or combination selected from the group consisting of alumina fiber and alumina-silica fiber.

8. The aluminum based composite material according to claim 1, wherein the matrix contains magnesium of from about 0.4 to about 8.5 percent by mass, where a total of the matrix is defined as 100 percent by mass.

9. The aluminum based composite material according to claim 8, wherein the matrix contains magnesium of from about 0.4 to about 6 percent by mass.

10. The aluminum based composite material according to claim 8, wherein the matrix contains magnesium of from about 0.9 to about 8.5 percent by mass.

11. The aluminum based composite material according to claim 8, wherein the matrix contains magnesium of from about 2.2 to about 3.8 percent by mass.

12. The aluminum based composite material according to claim 1, wherein tensile strength of the aluminum based composite material is about 300 MPa or above after the aluminum based composite material has been heated at about 200° C. for about 165 hours.

13. The aluminum based composite material according to claim 12, wherein the tensile strength of the aluminum based composite material is about 310 MPa or above.

14. The aluminum based composite material according to claim 13, wherein the tensile strength of the aluminum based composite material is about 320 MPa or above.

15. The aluminum based composite material according to claim 1, wherein the aluminum based composite material is used for a constituent component of a compressor for an air conditioner.

16. The aluminum based composite material according to claim 1, wherein the nitriding short fiber is made by nitriding one of alumina-silica short fiber and alumina short fiber.

17. The aluminum based composite material according to claim 16, wherein the alumina-silica short fiber ranges from about 2 to about 4 μm in diameter and from about 50 to about 200 μm in length.

18. The aluminum based composite material according to claim 16, wherein the alumina short fiber ranges from about 2 to about 4 μm in diameter and from about 50 to about 200 μm in length.

19. The aluminum based composite material according to claim 1, wherein the whisker includes SiC whisker and AlBO₃ whisker.

20. The aluminum based composite material according to claim 19, wherein the SiC whisker ranges from about 0.3 to about 1.4 μm in diameter and from about 5 to about 30 μm in length.

21. The aluminum based composite material according to claim 19, wherein the AlBO₃ whisker ranges from about 0.5 to about 1 μm in diameter and from about 10 to about 30 μm in length.

22. The aluminum based composite material according to claim 1, wherein the tensile strength of the aluminum based composite material is about 400 MPa or above at a predetermined room temperature before a heat treatment.

23. The aluminum based composite material according to claim 22, wherein the tensile strength of the aluminum based composite material is about 430 MPa or above.

24. The aluminum based composite material according to claim 23, wherein the tensile strength of the aluminum based composite material is about 460 MPa or above.

25. The aluminum based composite material according to claim 24, wherein the tensile strength of the aluminum based composite material is about 500 MPa or above.

26. A process for manufacturing an aluminum based composite material comprising the steps of:
preparing a nitriding preform including whisker and nitriding short fiber;
placing the nitriding preform in a mold;
impregnating a molten aluminum alloy containing magnesium into the nitriding preform by pouring the molten aluminum alloy into the mold while the molten aluminum alloy is being pressurized; and
solidifying the molten aluminum alloy for obtaining the aluminum based composite material.

27. The process for manufacturing an aluminum based composite material according to claim 26, wherein the preparing step includes nitriding a preform including whisker and short fiber.

28. The process for manufacturing an aluminum based composite material according to claim 26, wherein the preform is thermally treated in NH₃ gas at about 1400° C. for about two hours in the preparing step.

29. The process for manufacturing an aluminum based composite material according to claim 26, wherein the nitriding preform and the mold are heated from about 500 to about 800° C. before the impregnating step.

30. The process for manufacturing an aluminum based composite material according to claim 29, wherein the molten aluminum alloy is being pressurized under from about 80 to about 100 MPa in the impregnating step.

31. The process for manufacturing an aluminum based composite material according to claim 26, further comprising an additional step of treating the aluminum based composite material by solution heat treatment at about 200° C. for about 10 hours following the solidifying step

32. The process for manufacturing an aluminum based composite material according to claim 31, further comprising a subsequent step of treating the aluminum based composite material by artificially ageing hardening at about 170° C. for about 10 hours.
